(19) United States
(12) Patent Application Publication
(10) Pub. No.: US 2005/0066042 A1
(43) Pub. Date: Mar. 24, 2005

(54) Plug-in status interfacing

(76) Inventor: Jesse Adam Hummer, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,469

(22) Filed: Sep. 23, 2003

(51) Int. Cl. G06F 15/16

(52) U.S. Cl. 709/229

(57) ABSTRACT

A method of operating a plug-in to a host, the plug-in providing one or more special capabilities to the host. Such a method may include: interfacing to make available, from the plug-in to an external calling entity relative to the host, operational status information (Op_Stat_Info) regarding the plug-in. Related apparatus and machine-readable media having instructions that may include features similar to elements of the method.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

In the Background Art, a plug-in is a software module that tightly integrates with a larger program or application to add one or more special capabilities to the program. A plug-in is optional such that it need not be loaded for the larger program to operate. In contrast, a plug-in does not operate unless it is loaded on the larger program.

The larger program is designed to accept plug-ins, i.e., is designed according to a plug-in architecture. The maker of the larger program usually publishes a design specification according to which plug-ins can be written for loading onto the larger program.

Examples of applications familiar to the general public that have a plug-in architecture include the Adobe® brand Photoshop® model of photo-editing software and the Netscape® brand Navigator® model of browser. Examples of plug-ins familiar to the general public include the Kai® brand Power_Tools® model of plug-in for Photoshop® and the Macromedia® brand Shockwave® model of plug-in for Navigator®. In the area of storage area networks (SANs), the Hewlett-Packard Company brand of SAN, including its OpenView® Storage Area Manager (OVSAM®) model of storage-management tool, are an example of plug-in architectures.

It has been assumed in the Background Art that a plug-in is operating correctly if it has been loaded.

### SUMMARY OF THE INVENTION

An embodiment of the invention is directed towards a method of operating a plug-in to a host, the plug-in providing one or more special capabilities to the host. Such a method may include: interfacing to make available, from the plug-in to an external calling entity relative to the host, operational status information (Op_Stat_Info) regarding the plug-in.

Other embodiments of the invention include related apparatus and machine-readable media having instructions that may include features similar to elements of the method.

Additional features and advantages of the invention will be more fully apparent from the following detailed description of example embodiments and the accompanying drawings.

### BRIEF DESCRIPTION OF THE DRAWINGS

The drawings are: intended to depict example embodiments of the invention and should not be interpreted to limit the scope thereof.

FIG. 1 is an architecture diagram of a storage area network according to an embodiment of the invention.

FIG. 2 is a block diagram of a client-server architecture according to an embodiment of the invention.

And FIG. 3 is a block diagram of client_plug-in:server_plug-in architecture according to an embodiment of the invention.

### DETAILED DESCRIPTION OF EXAMPLE EMBODIMENTS

An embodiment of the invention, at least in part, is the recognition of the following. Merely because a plug-in has loaded does not necessarily mean that the plug-in is operating correctly. Problem diagnosis could be simplified and the problem more quickly corrected if operation status information regarding a loaded plug-in were available.

An embodiment of the invention, at least in part, is the further recognition of the following. A plug-in architecture makes possible the development of special capabilities not otherwise exhibited (and sometimes not contemplated to a significant level of detail, if contemplated at all) by the larger program into which a plug-in is to be plugged. Accordingly, an interface by which operational status information (Op_Stat_Info) can be gathered should be correspondingly generic or object-oriented in terms of the type and manner of transferring Op_Stat_Info so as to accommodate the necessarily unpredictable nature of future plug-in operation and the particularities of their corresponding Op_Stat_Info, respectively.

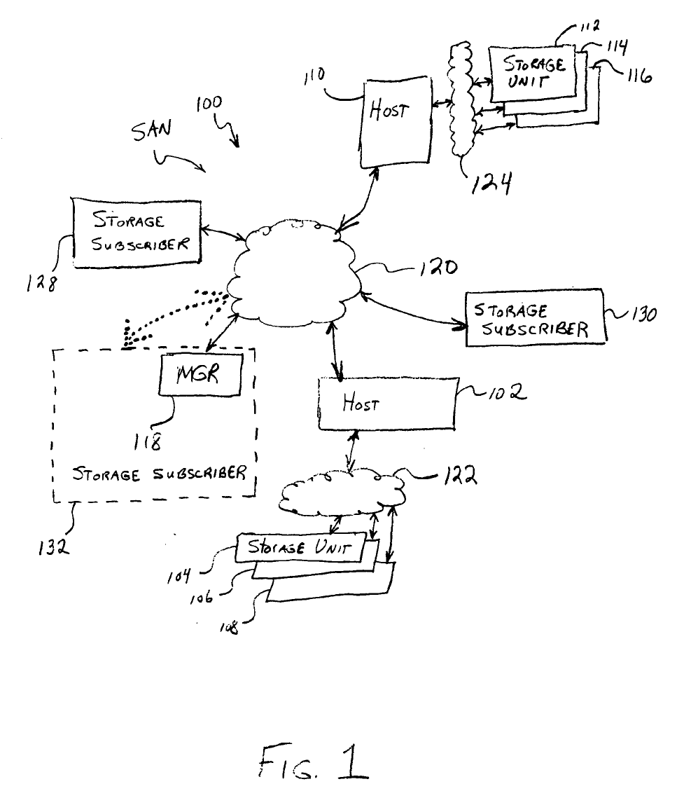

FIG. 1 is an architecture diagram of a distributed system, e.g., a storage area network (SAN), 100 according to an embodiment of the invention. Hosts are connected to the SAN 100. A host is a computer connected to a network via which the computer provides data and services to other computers.

Components of the SAN 100 include: a host, e.g., a storage provider, 102; one or more other hosts, e.g., storage providers, 110; a host, e.g., a storage area manager (SAM), 118; a host, e.g., a storage subscriber, 128 that consumes storage capability made available by a storage provider, e.g., 102; one or more other optional hosts, e.g., storage subscribers, 130; and a networking protocol and/or architecture (NPA) 120 through which at least the SAM 118 can communicate with each of the hosts 102 and 110. Optionally, the hosts 102 and 110 can communicate with each other though the NPA 120. For example, the NPA can include the internet or World Wide Web.

For each of the hosts 102 and 110, second NPAs 122 and 124 are depicted through which operative connection can be made to other nodes 104-108 and 112-116, respectively. The nodes can be sites of actual data storage, namely, storage units, of the SAN 100.

In general operation, the storage subscribers 128 and 130, respectively, are allotted a respective amount of storage capacity on the SAN 100. The allotment and management of the storage capacity is managed by the SAM 118. As an alternative (as indicated by the use of phantom lines), the SAM 118 can itself be an application loaded on a storage subscriber 132. Among other things, the SAM 118 can obtain operational status information (again, Op_Stat_Info) regarding each plug-in loaded on the host 102 and/or 110 that is configured with such capability (see below).

As will be described in detail below, the hosts loaded on the hosts 102 and 110 and the SAM 110 have a plug-in architecture adapted to support the exchange of various sets of Op_Stat_Info about the plug-ins that are plugged into (a.k.a. loaded on), e.g., the hosts on the hosts 102 and 110. An example of a plug-in architecture SAN that can be adapted according to the description provided below (and so represent an embodiment of the invention) is the Hewlett-Packard Company brand of SAN, including the OpenView® Storage Area Manager (OVSAM®) model of storage-management tool.

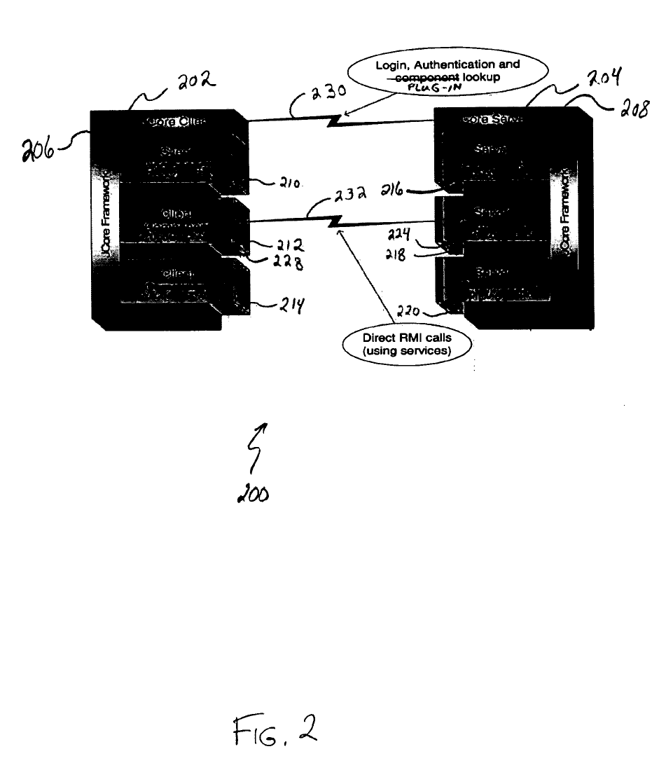

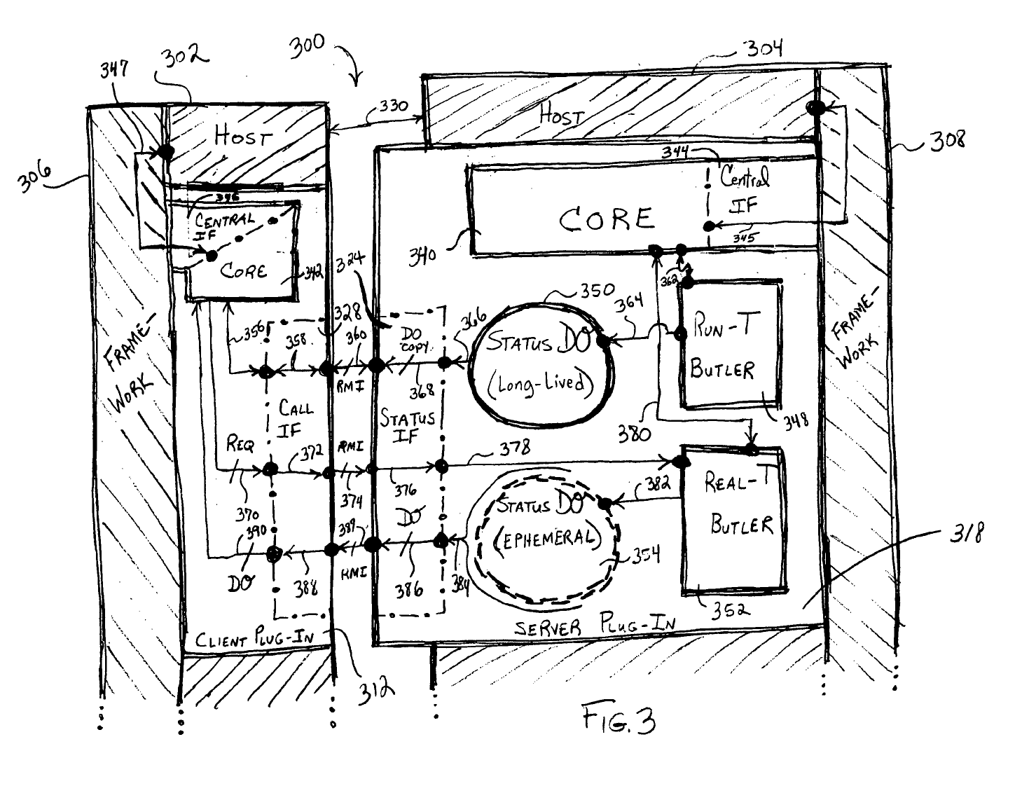

FIG. 2 is a block diagram of a client-server architecture 200 according to an embodiment of the invention. The architecture 200 can be a brokered-service type of client-server architecture. An example of a brokered-service type of framework technology upon which the client-server architecture 200 can be based is the Hewlett-Packard Company brand JCore™ variety of framework technology; another example is the Sun Microsystems Inc. brand Jini™ variety of framework technology.

Referring back to FIG. 1, relationships between the hosts 102, 110 and the SAM 118, respectively, and optionally between the hosts 102 and 110 themselves, can be based upon the client-server architecture 200. The example of the Hewlett-Packard Company brand of SAN, including OpenView® Storage Area Manager (OVSAM®) model of storage-management tool, mentioned above, can be adapted to the client-server architecture 200.

The client-server architecture 200 of FIG. 2 includes: a client 202; a server 204; a framework 206 supporting the client 202; a framework 208 supporting the server 204; client plug-ins 210, 212 and 214 plugged into, respectively, the framework 206 supporting the client 202; and plug-ins 216, 218 and 220 plugged into, respectively, the framework 208 supporting the server 204. For example, each of the blocks 202-220 (as well as 224 and 228 discussed below) can be of the JCore™ variety.

Again, a plug-in is typically a software module that tightly integrates with a larger program or larger system to add one or more special capabilities to the larger system. A plug-in is optional relative to the larger system in the sense that the plug-in need not be loaded for the larger system to operate. In contrast, a plug-in typically does not operate unless it is loaded on the larger system. Alternatively, the plug-in can be a hardware unit or a combination of a hardware unit and software module. Correspondingly, the larger system is designed to accept plug-ins, i.e., is designed according to a plug-in architecture. The maker of the larger system usually publishes a design specification according to which plug-ins can be written for loading onto the larger system.

During typical operation of a plug-in (by which the special capabilities of the plug-in are conferred upon the host into which the plug-in is plugged), information (hereafter, “typical information”) is exchanged between the plug-in and the larger system. In FIG. 2, the client 202 and the server 204 each represent a larger system with respect to the plug-ins 210-220, respectively. A central interface is provided by which the typical information can be exchanged between the plug-in and the corresponding host. The plug-ins 210-220 have central interfaces that are indicated by depicting a side edge of the plug-in as being contiguous with a side portion of the corresponding framework 206 and 208, respectively, e.g., the contiguous edge between the client plug-in 212 and the framework 206 of the client 202, or the server plug-in 218 and framework 208 of the server 204.

In FIG. 2, a path 230 is depicted between the client 202 and the server 204. The path 230 represents a basic operative connection, e.g., of the JCore™ variety. Via path 230, login, authentication, plug-in look-up, etc., can take place.

The client plug-in 212 and the server plug-in 218 each have one or more remote interfaces 228 and 224, respectively. In FIG. 2, a path 232 is depicted between one of the one-or-more remote interfaces 228 of the client plug-in 212 and one of the one-or-more remote interfaces 224 of the server plug-in 218. The path 230 represents an operative connection, based upon an application-programming interface (API) for remote procedure calls, e.g., using services compatible with the remote method invocation (RMI) set of protocols.

As will be described in detail below, the client-server architecture 200 has a plug-in architecture adapted to support the exchange of various operation status information (again, Op_Stat_Info) about the plug-ins that are plugged in (a.k.a. loaded).

FIG. 3 is a block diagram of client_plug-in:server_plug-in architecture 300, according to an embodiment of the invention, that is adapted to support the exchange of various Op_Stat_Info about plug-ins that are plugged in (a.k.a. loaded). The architecture 300 includes a host 302 and a host 304. As an example: the host 302 can correspond to the SAM 118 of FIG. 1 and/or the client 202 of FIG. 2; and the host 304 can correspond to one of the hosts 102 and 110 in FIG. 1 or the server 204 of FIG. 2. A path 330, corresponding to path 230 of FIG. 2, is depicted between the host 302 and the server 304. Similarly, the path 330 represents a basic operative connection for login, authentication, plug-in look-up, etc., and can be, e.g., of the JCore™ variety.

The host 302 can include: a framework 306 for plug-ins; a client plug-in 312; a call interface (IF) 328; a core 342 and a central interface (IF) 346. The host 308 can include: a framework 308; a server plug-in 318; a status interface (IF) 324; a core 340 and a central interface (IF) 344. The server plug-in 318 further includes: a run-time component or butler 348; a long-lived status data object (DO) (hereafter status_DO) 350; a real-time component or butler 352; and an ephemeral status_DO 354.

In FIG. 3, the blocks 306, 308, 312 and 318 can correspond to the blocks 206, 208, 212 and 218 of FIG. 2, respectively. The call IF 328 and the status IF 324 can correspond to one of the one-or-more remote IFs 228 and 224 of FIG. 2, respectively. Similarly, the blocks 302-308, 312, 318, 324, 328, 340, 342, 344 and 346 can be, e.g., of the JCore™ variety.

A core can be the part of a plug-in that carries out the typical operations by which the special capabilities of the plug-in are conferred upon the host into which the plug-in is plugged. Again, such typical operation includes an exchange of typical information. The core 342 of the client plug-in 312 exchanges its respective typical information with the host 302 via the central IF 346 and the framework 306 over the path 347. The core 340 of the server plug-in 318 exchanges its respective typical information with the host 304 via the central IF 344 and the framework 308 over the path 345.

Special capabilities conferred by the client plug-in 302 include the ability to obtain various sets of information (again, Op_{—Stat}_Info) regarding the operational status of one or more plug-ins, e.g., 318, plugged-in/loaded-on one or more hosts, respectively, e.g., 304. Because the plug-in 312 requests and receives information from the plug-in 318, the plug-in 312 can be thought of as a client and the plug-in 318 can be thought as a server relative to each other, hence they are dubbed the client plug-in 312 and the server plug-in 318.

Each of the run-time butler 348 and the real-time butler 352 has a bidirectional connection 362 and 380, respectively, over which the respective sets of Op_Stat_Info concerning, e.g., data objects and threads in the core 340 are, gathered. For example, the core 340 might include several methods (that are called and are expected to return a result in a reasonable elapse of time) whose individual operational status is desired to be known. The run-time butler 348 gathers various Op_Stat_Info in an on-going manner while the plug-in 318 is plugged into the host 304. In contrast, the real-time butler 352 gathers various Op_Stat_Info in reply to a request from the client plug-in 312; this can be described as an ad hoc manner. In other words, the real-time butler 352 probes for information rather than waiting for the information to develop and evolve.

While shown as two separate blocks, the butlers 348 and 352 alternatively can be a single entity, e.g., a JAVA method, whose manner of gathering data is dictated by the manner in which it is called.

The run-time varieties of Op_Stat_Info are couched from the perspective of the server plug-in 318. Examples of run-time Op_Stat_Info include an indication of whether the plug-in 318 is: initializing; okay; broken; shutdown; etc. The real-time varieties of Op_Stat_Info are couched from the perspective of the client plug-in 312.

Upon initially gathering a piece of the Op_Stat_Info, the run-time butler 348 stores it via the long-lived status_DO 350, as indicated by path 364. For ease of depiction, the long-lived status_DO 350 is shown inside the server component 318, but it could be located elsewhere. Also, the long-lived status_DO can be created before the initial piece of run-time Op_Stat_Info is gathered, or can be created upon the first piece of run-time Op_Stat_Info having been gathered. After a piece of the Op_Stat_Info is initially gathered and stored, the run-time butler 348 can update that piece of the Op_Stat_Info appropriately with respect to the on-going manner by which the run-time Op_Stat_Info is gathered.

In terms of an amount of time in which access can be had by the corresponding butler 348/352, the status_DO 350 can be described as long-lived relative to the status_DO 354 (as will be discussed in detail below). Similarly, the status_DO 354 can be described as ephemeral relative to the status_DO 350. The relatively ephemeral nature of the status_DO 354 is indicated by its being drawn in phantom lines.

The run-time Op_Stat_Info can be obtained as follows. Using the call IF 328 (as indicated with bidirectional paths 356 and 358), the core 342 of the client plug-in 312 can communicate (as indicated with bidirectional path 360) with status IF 324 of the server plug-in 318. The status IF 324 can provide (as indicated by the unidirectional paths 366 and 368) a copy of the long-lived status_DO 350 to the core 342.

The run-time Op_Stat_Info can be obtained as follows. Using the call IF 328 (as indicated with uni-directional paths 370 and 372), the core 342 of the client plug-in 312 can communicate (as indicated with uni-directional path 374) with the real-time butler 352 via the status IF 324 of the server plug-in 318.

Upon receiving a request for real-time Op_Stat_info from the core 342, the real-time butler 352 gathers the real-time Op_Stat_Info from the core 340 (as indicated with bidirectional path 380). The real-time butler 352 causes the ephemeral status_DO 354 to be created and located temporarily in the server plug-in 318. Then the run-time butler 352 stores (as indicated by path 382) in it the ephemeral status_DO 354. Alternatively, the ephemeral status_DO 354, like the status_DO 350, can be located somewhere other than the server plug-in 318. Upon completion of the information gathering, the real-time butler 352 passes the ephemeral status_DO 354 to the core 342, as indicated by the uni-directional paths 384, 386, 387, 388 and 390.

The paths 360, 374 and 387 can correspond to the path 232 of FIG. 2, and as such can each represent an operative connection, e.g., based upon the RMI type of API.

A more detailed example embodiment of the invention follows. This example is of a java interface named ComponentStatusIF.

An application Y, e.g., the client plug-in 312, that wants to know the status of a plug-in (in this example referred to as “componentX”), e.g., server plug-in 318, can use the ComponentStatusIF (which can correspond to the call IF 328 and the status IF 324 taken together). The client plug-in 312 would check if components implements ComponentStatusIF, and if so, casts componentX to ComponentStatusIF and calls a method, e.g., getComponentStatus(boolean) (which is also part of this example) to obtain the status information. Run-time status in formation can be obtained, e.g., by calling getComponentStatus(false) and real-time status information can be obtained, e.g., by calling getComponentStatus(true).

The interface ComponentStatusIF allows both a general status information and a component-specific (plug_in-specific) detailed status information to be returned. General status codes map to a pre-defined set of states (see below). General status information generically assesses the overall health of a component. Detail status information is specific to the component that returned the value(s)

Detail status information is communicated via a free-form field that expects the recipient to have component-specific (plug_in-specific) knowledge for interpreting the value(s) that are returned. Detail status information for a specific component is not necessarily meaningful for any other component, and is translated with respect to the component that was called. Detail status information can provide granularity beyond the general status information, but is not communicated in a component-independent, generic manner as is the circumstance for the general status information.

The following table extends the example by defining examples of specific general status codes.

| Status Code | Run-time | Real-time | Calling App |
|---|---|---|---|
| STATUS_OK | X | X | |
| STATUS_BROKEN | X | X | |
| STATUS_INITIALIZING | X | X | |
| STATUS_SHUTDOWN | X | X | |
| STATUS_DISABLED | X | X | |
| STATUS_NOT_RESPONDING | | X | X |
| STATUS_UNSUPPORTED | | | X |

The componentX (e.g., by way of the butler 348) stores the run-time Op_Stat_Info (e.g., a general status code) in a data object known as StatusContainer (which can correspond to the long-lived DO 350 and the ephemeral DO 354). The butler 348 updates this run-time Op_Stat_Info as the componentX (more particularly, e.g., the core 340) transitions from one state to another at run-time. The general status code is then returned, via the passing of a copy of the StatusContainer DO, when the example method to obtain run-time status, namely getComponentStatus(false), is called. Additional calls are not needed to determine status. The duration of a call for Op_Stat_Info should not block indefinitely; rather it should grab a stored value and return immediately.

When the example method to obtain real-time status (namely, getComponentStatus(true)) is called, the butler 352 attempts to test (or probe) the functionality of the core 340. Nothing should be retrieved from previously-stored values as part of the process of gathering the real-time Op_Stat_Info. As a precaution, the following states can be checked before proceeding with a functionality probe: STATUS_SHUTDOWN; STATUS_DISABLED; STATUS_BROKEN; and STATUS_INITIALIZING.

A call to the getComponentStatus(true) method might block indefinitely. Accordingly, care should be given to the amount of work attempted in the call to make it likely that this method returns before the calling application determines the call has timed out. See the discussion of getSuggestedTimeout( ) below for more detail on timeout values.

Three code samples are provided below as example implementations of the interface ComponentStatusIF. The code samples can be cut and pasted into Java source files, compiled and run. The first code sample (“TestClient.java”) represents the client side application (e.g., the client plug-in 312) that does the status checking. The second code sample (“MyComp.java”) is a generic server plug-in, e.g., 318, referred to as Server Component. The third code sample (“StatusTester.java”) is the remote object that ServerComponent contains. As such, the third code sample implements ComponentStatusIF on the server side, and can be viewed as corresponding to the butlers 348 and 352.

The code sample TestClient java follows. TestClient java checks the status for all plug-ins loaded on a JCore™ server, e.g., 304, that are compatible, e.g., that have the status IF 324, etc. TestClient.java, among other things, can: retrieve a list of component interfaces; see if the components implement ComponentStatusIF; and spawn a thread to check status, allowing for a timeout mechanism.

```
  import java.util.*;
  import java.rmi.*;
  import com.hp.jcore.framework.*;
  import com.hp.jcore.util.*;
  public class TestClient {
    public static void main( String[ ] args ) {
      TestClient t = new TestClient( );
      if (args.length == 0) {
        t.checkStatus(“localhost”, “JCoreServer”); //default values
      }
      else if (args.length == 2) {
        t.checkStatus(args[0], args[1]); //user's values
      }
      else {
        System.err.println(“ERROR in usage: java TestClient [ ]” );
        System.exit(1);
      }
      System.exit(0);
    }
    private String translateCode( int code ) {
      String rtn;
      switch (code) {
        case ComponentStatusIF.STATUS_OK : rtn = “STATUS_OK”; break;
        case ComponentStatusIF.STATUS_BROKEN : rtn = “STATUS_BROKEN”; break;
        case ComponentStatusIF.STATUS_INITIALIZING : rtn = “STATUS_INITIALIZING”;
  break;
        case ComponentStatusIF.STATUS_SHUTDOWN : rtn = “STATUS_SHUTDOWN”; break;
        case ComponentStatusIF.STATUS_DISABLED : rtn = “STATUS_DISABLED”; break;
        case ComponentStatusIF.STATUS_NOT_RESPONDING : rtn =
  “STATUS_NOT_RESPONDING”; break;
        case ComponentStatusIF.STATUS_UNSUPPORTED : rtn = “STATUS_UNSUPPORTED”;
  break;
        default : rtn = “ERROR: Invalid status code: ” + code;
      }
      return rtn;
    }
    public void checkStatus( String host, String service ) {
      //--connect to the server--
      ServiceDescriptor target = new ServiceDescriptor( );
      target.setStringValue(ServiceDescriptor.SERVICE_NAME, service);
      target.setStringValue(ServiceDescriptor.SERVER_HOST, host);
      ProfileDictionary profile = new ProfileDictionary( );
      profile.setStringValue(“COMPONENT_DB”, “Components.prp”);
      profile.setBooleanValue(“VERBOSE”, true);
      ClientFramework sc = new ClientFramework(profile, target);
      int rc = sc.waitForLogon( );
      if (rc == ClientFramework.LOGIN_SUCCESS) {
        try {
          ClientComponentMgr cmgr = sc.getComponentMgr( );
          Vector comps = cmgr.listServerInterfaces( );
          //--for each component--
          for( Enumeration e = comps.elements( ); e.hasMoreElements( ); ) {
            String compname = (String)e.nextElement( );
            System.out.println(compname);
            Remote rcomp = cmgr.getServerInterface(compname);
            if (rcomp != null) {
              if (rcomp instanceof com.hp.jcore.framework.ComponentStatusIF ) {
                //--cast it--
                ComponentStatusIF comp = (ComponentStatusIF)rcomp;
                //--get RUN-TIME status--
                StatusContainer run-timeStat = comp.getComponentStatus(false);
                //--extract general and detail status--
                int generalStatus = run-timeStat.getGeneralStatus( );
                long detailStatus = run-timeStat.getDetailStatus( );
                //--extract message--
                String[ ] msg = run-timeStat.getMessage( );
                //--display the results--
                System.out.println(“ RUN-TIME”);
                System.out.println(“ general status=” + translateCode(generalStatus) );
                System.out.println(“ detail status=” + Long.toBinaryString(detailStatus)
  );
                System.out.print (“ message=[”);
                for ( int ix = 0; ix < msg.length; ix++ ) {
                System.out.print( msg[ix] );
                if ( ix + 1 != msg.length ) {
                  System.out.print( “,” );
                }
              }
              System.out.println( “]” );
              //--get REALTIME status by proxy of a ProbeStatus object--
              ProbeStatus probe = new ProbeStatus(comp);
              Thread t = new Thread(probe);
              t.setDaemon(true);
              t.start( );
              //--use timeout suggested by component--
              long timeout = (comp).getSuggestedTimeout( );
              //--some sanity checking--
              if (timeout <= 0 || timeout > 60000) {
                System.err.println( “!!! Unreasonable suggested timeout (“
                    +timeout+”), using 60000 instead” );
                timeout=60000;
              }
              long startTime = System.currentTimeMillis( );
              t.join(timeout);
              long endTime = System.currentTimeMillis( );
              StatusContainer realtimeStat;
              if (probe.isCompleted( )) {
                realtimeStat = probe.getResults( );
              }
              else {
                realtimeStat = new StatusContainer(
ComponentStatusIF.STATUS_NOT_RESPONDING,
                        0L,
                        new String[ ]{ } );
                t.stop( ); // The stop is optional!
              }
              //--extract general and detail status--
              generalStatus = realtimeStat.getGeneralStatus( );
              detailStatus = realtimeStat.getDetailStatus( );
              //--extract message--
              msg = realtimeStat.getMessage( );
              //--display the results--
              System.out.println(“ REALTIME”);
              System.out.println(“ suggestedTimeout=” + timeout);
              System.out.println(“ actualWaitTime=” + (endTime-startTime) );
              System.out.println(“ general status=” + translateCode(generalStatus) );
              System.out.println(“ detail status=” + Long.toBinaryString(detailStatus);
              System.out.print (“ message=[”);
              for ( int ix = 0; ix < msg.length; ix++) {
                System.out.print( msg[ix] );
                if ( ix + 1 != msg.length ) {
                  System.out.print( “,” );
                }
              }
              System.out.println( “]” );
            }
            else {
              System.out.println(“ ” +
translateCode(ComponentStatusIF.STATUS_UNSUPPORTED) );
            }
          }
          else {
            System.out.println(“ component is null”);
          }
        }
      }
      catch( Exception re ) {
        System.err.println( re );
      }
      sc.shutdown( );
    } //if success
    else {
      String msg = ClientFramework.getLoginResultMsg(rc);
      System.err.println(“Client failed to log in to server. Login Result=“+rc+” “+msg);
      System.exit(−1);
    }
  } //checkStatus
  private class ProbeStatus implements Runnable {
    public ProbeStatus( ComponentStatusIF comp ) {
      m_comp = comp;
    }
    public boolean isCompleted( ) {
      return m_completed;
    }
    private ComponentStatusIF m_comp;
    private boolean m_completed = false;
    private StatusContainer m_results
        = new StatusContainer( ComponentStatusIF.STATUS_NOT_RESPONDING, 0L, new
String[ ]{ } );
    public StatusContainer getResults( ) {
      return m_results;
    }
    public void run( ) {
      try {
        m_results = m_comp.getComponentStatus(true);
        m_completed=true;
      }
      catch( Exception e ) {
      }
    }
  } //inner class ProbeStatus
  } //class TestClient
              The code sample MyComp.java follows. Again, it is generically a
  core, e.g., 340, of a plug-in, e.g., 318.
  import com.hp.jcore.framework.*;
  import com.hp.jcore.util.*;
  import java.rmi.*;
  public class MyComp extends ServerComponent {
    public static final String NAME = “MYCOMP”;
    public String getName( ) {
      return NAME;
    }
    public Remote getServerInterface( ) {
      return m_remote;
    }
    public void initialize(ComponentInfo inf, ComponentMgr mgr) {
      super.initialize(inf,mgr);
      try {
        m_remote = new StatusTester( );
      }
      catch ( Exception re ) {
        re.printStackTrace( );
      }
      System.out.println(“MyComp initialized. m_remote is ” + m_remote.getClass( ).getName( )
  );
    }
    private StatusTester m_remote;
  }
```

The code sample StatusTester.java follows. Again, StatusTester.java can correspond to the butlers 348 and 352. Because it is generically represented, the code sample MyComp.java does not have particular operational aspects which can be probed by StatusTester.java. Accordingly, the data gathering in StatusTester.java is faked by having StatusTester.java sleep for awhile. Nevertheless, an example of structure and logic for implementing the interface is demonstrated.

```
  import java.rmi.*;
  import java.rmi.server.*;
  import com.hp.jcore.framework.*;
  public class StatusTester extends JCoreUnicastRemoteObject implements ComponentStatusIF
  {
    public StatusTester( ) throws RemoteException {
      super (ServiceManager.getSuggestedRemotePort ( ));
      m_run-timeStatus.setGeneralStatus(ComponentStatusIF.STATUS_OK);
      m_run-timeStatus.setDetailStatus(0xABCDEFL);
      m_run-timeStatus.setMessage(new String[ ] {“code1”,“run-time”,“constructed”} );
    }
  //--- BEGIN INTERFACE: ComponentStatusIF -------------------------------
    public StatusContainer getComponentStatus( boolean probe ) throws RemoteException {
      StatusContainer sc = null;
      if ( probe ) {
        //--this is where the actual probe takes place--
        try{
          //--First check for the following:
          //  SHUTDOWN
          //  DISABLED
          //  BROKEN
          //  INITIALIZING
          //--Now probe--
          //... we're faking it here since this component doesn't
          //  really do anything.
          Thread.currentThread( ).sleep(2500);
          sc = new StatusContainer( ComponentStatusIF.STATUS_OK,
                  0x0abcdefL,
                  new String[ ] { “code2”,“realtime”,“ok” } );
        }
        catch( InterruptedException ie ) {
          //exception while sleeping, no biggie for this example
        }
      }
      else {
        sc = m_run-timeStatus;
      }
      return sc;
    }
    public long getSuggestedTimeout( ) throws RemoteException {
      return m_timeout;
    }
  //--- END INTERFACE: ComponentStatusIF -------------------------------
  //--stuff to keep track of when implementing ComponentStatusIF--
  protected StatusContainer m_run-timeStatus
    = new StatusContainer( ComponentStatusIF.STATUS_INITIALIZING,
            0L,
            new String[ ] { “code0”,“run-time”,“not initialized yet” } );
  protected long m_timeout = 5000L;
}
```

More detail is now provided regarding the general status codes (gen_stat_code) that are part of the example. Each of the example general status codes can take the form: public static final int gen_stat_code.

The gen_stat_code named STATUS_UNSUPPORTED indicates that the current status of componentX is not able to be determined because componentX does not support status operations.

The gen_stat_code named STATUS_INITIALIZING indicates that componentX is still in the process of initializing itself.

The gen_stat_code named STATUS_OK indicates that componentX is loaded, started, initialized, and fully functional. Full functionality is determined on a per-component basis.

The gen_stat_code named STATUS_NOT_RESPONDING indicates that componentX has been probed for status, and either the calling application has timed out on the call to getComponentStatus(true) or the getComponentStatus(true) method determined one or more of it's functions has timed out. Typically, calling getComponentStatus(false) will not return STATUS_NOT_RESPONDING because it relates to run-time Op_Stat_Info, for which no probing takes place; a more appropriate status code to return in such a circumstance would be STATUS_BROKEN.

ComponentX can return STATUS_NOT_RESPONDING for real-time status if one of its functions does not respond within a timely manner. In such a circumstance, componentX should not necessarily be described as STATUS_BROKEN. Instead, its general status is undetermined because a part of componentX did not respond. Rather than allowing the whole process to be blocked and potentially leave threads hanging around on a server, componentX might spawn a thread to check a particular function and timeout if that function did not return in a timely manner (then clean the up non-responding threads). ComponentX would then return STATUS_NOT_RESPONDING for getComponentStatus(true). With this technique, componentX can also provide more granular information in the message and detail status portions of the StatusContainer as to which part timed out.

While componentX is not required to return STATUS_NOT_RESPONDING as described above, it also is not restricted from doing so. As such, a calling application should expect STATUS_NOT_RESPONDING to be a valid return value for a call to getComponentStatus(true).

The gen_stat_code named STATUS_BROKEN indicates that componentX has determined itself to be broken in some way that is crucial to its proper operation.

The gen_stat_code named STATUS_SHUTDOWN indicates that componentX has been shutdown but is still loaded.

The gen_stat_code named STATUS_DISABLED indicates that componentX is loaded and responsive, but is in a disabled state, such that it must be enabled (per some component-specific mechanism) in order to be useful. The concept of “enabled” status is implied in the other status values.

More detail is now provided regarding the methods getComponentStatus and getSuggestedTimeout that are part of the example.

The method getComponentStatus typically can take the form:
public StatusContainer getComponentStatus(boolean probe) throws RemoteException

The method getComponentStatus gets the status of componentX, returning the StatusContainer object that can contain a general status code, a component-specific detailed status code, and a message.

If probe is true, getComponentStatus returns status by actively probing for status at the time of this method call. This is a blocking call that has the potential to never return. It is advisable for the caller spawn a thread that calls this method, and join that thread for a period of time.

If probe is false, getComponentStatus returns the latest status code as set and updated by componentX, e.g., butler 348, at run-time. As no probing takes place; this call should not block indefinitely.

The method getSuggestedTimeout typically can take the form:
public long getSuggestedTimeout( ) throws RemoteException

The method getSuggestedTimeout returns a timeout value in milliseconds. This number represents an estimate of the time in which a call to getComponentStatus(true) should complete. This is merely a suggested value. Knowing how long a call might take is advantageous in that it is not necessary to wait for a maximum timeout period if it is known that componentX should only take a small fraction of the maximum timeout.

More details regarding data objects corresponding to StatusContainer follow. Again, componentX (e.g., by way of the butler 348) stores Op_Stat_Info via an instance of the java class StatusContainer. Each such instance can correspond to the long-lived DO 350 and the ephemeral DO 354. Each instance of StatusContainer can take the form: public class StatusContainer. This class is intended for use by ComponentStatusIF (see discussion above).

The class StatusContainer includes three parts: a general status (int); a detail status (long); and a message (String[ ]). The first and second parts have been discussed above. The third part, message (String[ ]), represents a set of character strings. A first type of string can be a value for indexing into a look-up table (LUT) of longer messages that are specific to the particular plug-in for which Op_Stat_Info is being gathered. Such longer messages can include one or more blanks. A second type of string can represent one or more values used to populate the one or more blanks in the message obtained via the first string. A third type of string can be a human-readable message.

The example is further extended by providing two constructors used to instantiate StatusContainer. The first constructor can take the form:
public StatusContainer(int gen, long det, String[ ] msg).
   The first constructor creates a new instance of StatusContainer and populates it with values. The second constructor can take the form:
public StatusContainer( ).
   The second constructor creates a new empty StatusContainer and populates it with default values, e.g.: general status=ComponentStatusIF.STATUS_UNSUPPORTED; detail status=zero; and message=an empty String array.

The example is further extended by providing methods by which by the butlers 348 and 352 can populate an instance of StatusContainer. Such methods include: setGeneralStatus; validateGeneralStatus; getGeneralStatus; setDetailStatus; getDetailStatus; setMessage; and getMessage.

The method setGeneralStatus can take the form:
public void setGeneralStatus(int genstat).
   SetGeneralStatus operates to set the general status of a StatusContainer DO. The parameter genStat should be a valid general status as defined in ComponentStatusIF or else an IllegalArgumentException should be thrown.

The method validateGeneralStatus can take the form:
public static boolean validateGeneralStatus(int stat).
   ValidateGeneralStatus operates to check if the parameter stat is one of the pre-defined general status values (see above). It returns the value true if the parameter stat is valid, false if invalid.

The method getGeneralStatus can take the form:
public int getGeneralStatus( )
   The value returned by getGeneralStatus is a general status code.

The method setDetailStatus can take the form:
public void setDetailStatus(long detStat)
   The detail status value is set by setDetailStatus. The value can be any long value.

The method getDetailStatus can take the form:
public long getDetailStatus( )
   The value returned by getDetailStatus is a detail status code.

The method setMessage operates to set the message. It can take the form:
public void setMessage(String[ ] msg)

The method getMessage can take the form:
public String[ ] getmessage( )

The method getMessage can returns a string array representation of a message, or an empty string array if no value has been set. In a simple form, the string array can contain a single string representing the message. An array is used, as alluded to above, in order to support localizable messages. In this case the string array would include a message code in element 0. The code of element 0 would be resolved to a pattern for a java.text.MessageFormat object. The remaining elements in the array would represent fields (if any) that populate the pattern.

As is apparent from the foregoing, embodiments of the invention can take the form of methods, software and computers adapted to run such software and/or methods. The software can be offered to the user in the form of a computer-readable storage medium. The storage medium may be a built-in medium installed inside a computer main body or removable medium arranged so that it can be separated from the computer main body. Examples of the built-in medium include, but are not limited to, rewriteable non-volatile memories, such as ROMs and flash memories, and hard disks. Examples of the removable medium include, but are not limited to, optical storage media such as CD-ROMS and DVDs; magneto-optical storage media, such as MOs; magnetism orage media, such as floppy disks (trademark), cassette tapes, and removable hard disks; media with a built-in rewriteable non-volatile memory, such as memory cards; and media with a built-in ROM, such as ROM

While several of the discussed embodiments of the inventions arise in the context of a SAN, such a context should not be considered a limitation upon the invention.

The invention being thus described, it will be obvious that the same may be varied in many ways. Such variations are not to be regarded as a departure from the spirit and scope of the invention, and all such modifications are intended to be included within the scope of the invention.

1. A plug-in to a host, the plug-in providing one or more special capabilities to the host, the plug-in comprising:
core means for conducting typical operation of the plug-in by which the one or more special capabilities are carried out; and
interface means for interfacing between the core means and a calling entity with respect to operational status of the plug-in.

2. The plug-in of claim 1, wherein:
the interface means is a first interface means; and
the plug-in further comprises
second interface means for interfacing between the core means and the host with respect to the typical operation.

3. The plug-in of claim 1, wherein:
the host tends one or more storage devices and represents a part of a storage area network (SAN); and
the calling entity represents a storage manager of the SAN.

4. The plug-in of claim 1, wherein, relative to a client-server architecture, the following relationships apply:
the calling entity represents a client relative to the plug-in; and
the plug-in represents a server relative to the calling entity.

5. The plug-in of claim 4, wherein the client-server architecture is the JCore architecture such that the calling entity is a JCore client plug-in and the plug-in is a JCore server plug-in.

6. The plug-in of claim 1, further comprising:
butler means for gathering operational status information (Op_Stat_Info) representing the operational status of the plug-in.

7. The plug-in of claim 6, wherein the butler means is operable for performing the gathering of the Op_Stat_Info in an on-going manner while the plug-in is plugged-into the host.

8. The plug-in of claim 7, wherein the butler means is further operable to
cause one or more pieces of the Op_Stat_Info to be stored upon the one or more pieces being gathered initially, respectively; and
update the one or more pieces, respectively, as is appropriate relative to the on-going manner by which the butler means gathers the Op_Stat_Info.

9. The plug-in of claim 8, further comprising:
status data object (DO) means for storing the Op_Stat_Info;
wherein
the butler means is further operable for causing the Op_Stat_Info to be stored via the status DO means,
the status DO means is accessible by the calling entity via the interface means.

10. The plug-in of claim 6, wherein the butler means is operable for initiating the gathering the Op_Stat_Info in response to receiving a request from the calling entity, and
for performing the gathering, once initiated, of the Op_Stat_Info in an ad hoc manner.

11. The plug-in of claim 10, further comprising:
status data object (DO) means for storing the Op_Stat_Info;
wherein the butler means is further operable for
causing the Op_Stat_Info to be stored via the status DO means, and
passing, upon completion of the gathering, the status DO to the calling entity.

12. A first plug-in to a host, the first plug-in providing one or more special capabilities to a host, the first plug-in comprising:
core means for conducting typical operation of the first plug-in by which the one or more special capabilities are carried out; and
interface means for interfacing between the core means and one or more second plug-ins loaded on one or more external, relative to the host, entities, respectively, regarding respective operational status of the one or more second plug-ins.

13. The first plug-in of claim 12, wherein:
the interface means is a first interface means; and
the first plug-in further comprises
second interface means for interfacing between the core means and the host with respect to the typical operation.

14. The first plug-in of claim 12, wherein:
the host is a first host;
the one or more external entities are one or more second hosts that tend one or more storage units, respectively;
the first host and the one or more second hosts represent a part of a storage area network (SAN); and
the host represents a storage manager of the SAN.

15. The first plug-in of claim 14, wherein, relative to a client-server architecture, the following relationships apply:
the first plug-in represents a client relative to the second plug-in; and
the second plug-in represents a server relative to the first plug-in.

16. The first plug-in of claim 15, wherein the client-server architecture is the JCore architecture such that the first plug-in is a JCore client plug-in and the second plug-in is a JCore server plug-in.

17. A method of operating a plug-in to a host, the plug-in providing one or more special capabilities to the host, the method comprising:
interfacing to make available, from the plug-in to an external calling entity relative to the host, operational status information (Op_Stat_Info) regarding the plug-in.

18. The method of claim 17, further comprising:
exchanging typical information between the plug-in and the host, the exchange of the typical information being a part of typical operation of the plug-in by which the one or more special capabilities are carried out.

19. The method of claim 17, wherein:
the host tends one or more storage devices and represents a part of a storage area network (SAN); and
the Op_Stat_Info is made available to a storage manager of the SAN.

20. The method of claim 17, further comprising:
gathering the Op_Stat_Info in an on-going manner while the plug-in is plugged-into the host.

21. The method of claim 20, further comprising:
storing one or more pieces of the Op_Stat_Info upon initially gathering the one or more pieces, respectively; and
updating the one or more pieces, respectively, as is appropriate relative to the on-going manner of the gathering step.

22. The method of claim 21, further comprising:
using a status data object (DO) to store the Op_Stat_Info; and
making the status DO accessible by the calling entity.

23. The method of claim 20, further comprising:
receiving a request from the calling entity for the Op_Stat_Info;
initiating the gathering step in response to receiving the request; and
performing the gathering step, once initiated, in an ad hoc manner.

24. The method of claim 23, further comprising:
using a status data object (DO) to store the Op_Stat_Info; and
passing, upon completing the gathering step, the status DO to the calling entity.

25. A machine-readable medium including instructions execution of which by a host produces a first plug-in, the first plug-in providing one or more special capabilities to the host, the machine-readable instructions comprising:
a core code segment for conducting typical operation of the first plug-in by which the one or more special capabilities are carried out; and
an interface code segment for interfacing between the core code segment and one or more second plug-ins loaded on one or more external, relative to the host, entities, respectively, regarding respective operational status of the one or more second plug-ins.

26. The machine-readable instructions of claim 25, wherein:
the interface code segment is a first interface code segment; and
the machine-readable instructions further comprise
a second interface code segment for interfacing between the core code segment and the host with respect to the typical operation.

27. The machine-readable instructions of claim 25, wherein:
the host is a first host; and
the one or more external entities are one or more second hosts that tend one or more storage units, respectively;
the first host and the one or more second hosts represent a part of a storage area network (SAN); and
the first host represents a storage manager of the SAN.

28. The machine-readable instructions of claim 25, wherein, relative to a client-server architecture, the following relationships apply:
the first plug-in represents a client relative to the second plug-in; and
the second plug-in represents a server relative to the first plug-in.

29. The machine-readable instructions of claim 28, wherein the client-server architecture is the JCore architecture such that the first plug-in is a JCore client plug-in and the second plug-in is a JCore server plug-in.

30. A method of operating a first plug-in to a host, the plug-in providing one or more special capabilities to a first host, the method comprising:
obtaining operational status information (Op_Stat_Info) from one or more second plug-ins loaded on one or more external, relative to the host, entities, respectively.

31. The method of claim 30, further comprising:
exchanging typical information between the first plug-in and the host, the exchange of the typical information being a part of typical operation of the plug-in by which the one or more special capabilities are carried out.

32. The method of claim 30, wherein:
the host is a first host; and
the one or more external entities are one or more second hosts that tend one or more storage units, respectively;
the first host and the one or more second hosts represent a part of a storage area network (SAN); and
the first host represents a storage manager of the SAN.

33. A machine-readable medium including instructions execution of which by a host produces a plug-in, the plug-in providing one or more special capabilities to the host, the machine readable instructions comprising:
a core code segment execution of which causes the one or more special capabilities to be carried out during typical operation of the plug-in; and
a status interface code segment for interfacing between the core and a calling entity and by which operational status of the plug-in is made available to the calling entity.

34. The machine-readable instructions of claim 33, further comprising:
a central interface code segment for interfacing between the core portion and the host and by which typical information is exchanged between the plug-in and the host, the exchange of the typical information being a part of the typical operation.

35. The machine-readable instructions of claim 33, wherein:
the host tends one or more storage devices and represents a part of a storage area network (SAN); and
the calling entity represents a storage manager of the SAN.

36. The machine-readable instructions of claim 33, wherein the plug-in, the host and the calling entity are configured according to the JCore architecture such that the calling entity represents a client relative to the plug-in and the plug-in represents a server relative to the calling entity.
